(19) United States
(12) Patent Application Publication
(10) Pub. No.: US 2020/0061555 A1
(43) Pub. Date: Feb. 27, 2020

(54) DYNAMIC MIXER AND DOSING DEVICE

(71) Applicant: ViscoTec Pumpen- u. Dosiertechnik GmbH, Töging a. Inn (DE)

(72) Inventors: Andreas KIRMEIER, Lohkirchen (DE); Patrick RINGARD, Polling (DE); Franz KAMHUBER, Heldenstein (DE)

(21) Appl. No.: 16/548,177

(22) Filed: Aug. 22, 2019

(30) Foreign Application Priority Data
Aug. 23, 2018 (EP) 18 190 466.5

(51) Int. Cl. B01F 7/00; B01F 15/02

(52) U.S. Cl. CPC B01F 7/00416; B01F 7/00216; B01F 7/00641; B01F 2215/0065; B01F 2215/005; B01F 2215/006; B01F 15/0247

(57) ABSTRACT

A dynamic mixer for a dynamic mixing operation for mixing a liquid or paste-like product, in particular a multi-component product, comprising a core element, a first blade element integrally formed with the core element and helically extending around the core element in a first helix direction, and a second blade element integrally formed with the core element and helically extending around the core element in a second helix direction that is different from the first helix direction, wherein the first blade element and the second blade element are arranged immediately adjacent when viewed in a longitudinal direction of the mixer, the first blade element having a first blade element height, when viewed in the longitudinal direction, and the second blade element having a second blade element height, when viewed in the longitudinal direction that is different from the first blade ele-ment height.

The present invention relates to a dynamic mixer for a dynamic mixing operation for mixing a liquid or paste-like product, in particular a multi-component product, and a dosing device comprising such a mixer.

In automation technology, dosing pumps having static or dynamic mixers downstream are used for applying single- or multi-component adhesives and/or sealants, or even paints or varnishes. These are, for example, piston or gear pump dispensers, or dispensers of the progressive cavity pump type, which, using a control unit, realize the exact amount or the volume and the mixing ratio at the input of the mixer. So-called static mixers with helical mixing panels perform a static mixing, whereby the two components are intermixed by being turned over multiple times. A dynamic mixer, on the other hand, is rotated about its central axis. An electric motor may be provided for this. In both cases, friction in the mixer can cause pressure losses the dosing pump must overcome. In particular with a compressible medium such as a microsphere adhesive, this may result in the microsphere adhesive relaxing after the dosing operation has been completed and the product continues to press out or drip out.

DE 20 2012 002 102 U1 describes a mixer suitable for a dynamic mixing operation. The mixer comprises a plurality of alternately arranged screw-like mixing elements having alternately differing helix directions. Viewed in a longitudinal direction of the mixer, all blade elements have the same height. The mixer further comprises an interface in the form of a thread, by means of which the mixer may be connected to a drive mechanism.

DE 20 2012 001 373 U1 shows a mixer for a dynamic mixing operation, the mixer having an undulated support rod member on which spaced apart turbulators are arranged. The mixer has turbulators having different heights.

Against this background, it is an object of the present invention to provide an improved mixer.

Accordingly, a dynamic mixer for a dynamic mixing operation for mixing a liquid or paste-like product, in particular a multi-component product, is proposed. The mixer comprises a core element, a first blade element integrally formed with the core element and helically extending around the core element in a first helix direction, and a second blade element integrally formed with the core element and helically extending in a second helix direction that is different from the first helix direction. The first blade element and the second blade element are arranged immediately adjacent, when viewed in a longitudinal direction of the mixer, the first blade element having a first blade element height, when viewed in a longitudinal direction, and the second blade element having a second blade element height that is different from the first blade element height, when viewed in the longitudinal direction.

The first blade element and the second blade element having different blade element heights allows for a reduction of a pressure build-up in the mixer, since, for example, the second blade element additionally serves as feed member and thus feeds the product to a nozzle section of a mixing device comprising the mixer. Due to the first blade element and the second blade element being arranged immediately adjacent, a higher mixing quality can be achieved with reduced mixing length.

The mixer may also be referred to as mixing helix, mixing member or mixing apparatus. The mixer may be part of a mixing device. The mixing device may have a mixing tube in which the mixer is accommodated. The mixer may be rotatably mounted in the mixing tube, in the case, where the mixer is a dynamic mixer. The mixer and the mixing tube may be disposable articles or so-called disposables. Meaning, the mixer and the mixing tube may be disposed of after a one-time use.

The mixing device may be associated with a drive mechanism comprising a drive member, for example an electric motor. The drive member may be coupled with the mixer by means of a drive shaft. The mixer may have an interface, with which the drive shaft positively engages. A positive connection is created by interlocking or engaging behind at least two connecting partners. For example, the drive shaft may be hooked into or screwed into the interface, which may be a boring. The mixing device may be part of a dosing device comprising one or more dosing pumps.

The product may comprise multiple components. For example, the product may comprise two components. However, the number of components is arbitrary. The product may be, for example, an adhesive and/or a sealant, water, an aqueous solution, a paint, a varnish, a suspension, a viscous raw material, an emulsion or a grease. The product or one of the components may further be or comprise a flowable material in its broadest sense, meaning, not only liquid, but also granular, such as plastic spheres, hollow plastic spheres, glass spheres or hollow glass spheres, or even a mixture that is inhomogeneous in particle size and/or material. For example, the product may be a two- or multi-component adhesive and/or sealant.

“Paste” or “paste-like product” means a solid-liquid mixture, in particular a suspension with a high content of solids. For example, the product may comprise a content of, in particular spherical, fillers such as so-called microballoons. Microballoons are hollow glass spheres or hollow plastic spheres or hollow polymer spheres. Hollow glass sphere may, for example, have a bulk density of 140 g/l to 150 g/l, a specific weight of 0.26 g/cm³, a particle size distribution of 50 μm and a maximum particle size of 200 μm. Furthermore, the product may be fiber-filled. For example, glass fibers, aramid fibers or carbon fibers may be used. Carbon nanotubes (CNT) may also be used as filler.

In particular, the product is compressible. The compressibility may result from the fillers, with which the product is filled. The product may, for example, be compressible up to a maximum pressure and be nearly incompressible from this maximum pressure. The microballoons mentioned above, for example, are compressible at a pressure from 0 bar to 15 bar, and from 15 bar, they can substantially not be compressed further. Only at a considerably higher pressure, for example from 30 bar, can the mircoballoons be compressed further because they may collapse or burst at this higher pressure. Furthermore, the microballoons may be damaged, for example pressed in, such that a permanently changed volume of the microballoons occurs. This applies in particular to hollow plastic spheres. It is therefore advantageous to dose and/or mix a product containing compressible fillers, in particular microballoons, such that the microballoons are not or only insignificantly compressed and thus the product pressing out after the dosing operation due to a relaxing of the microballoons is avoided or at least reduced.

“Compressible” means that the product is practically or substantially compressible. “Incompressible” further means that the product is practically or substantially incompressible. “Compressible” may, in particular, also mean that under a force or under a pressure the product is subjected to a volume change, in particular a volume reduction. The product may, for example, be slightly compressible again when pressure above the maximum pressure is applied. In particular, as mentioned above, the product may be further compressible at a significantly higher pressure then the maximum pressure. For example, the product may show a compressibility (volume change) of about 20% at a pressure of about 15 bar. In a range from 15 bar to 30 bar, the compressibility (volume change) may be characterized as virtually incompressible compared to a lower pressure range of 0 bar to 15 bar.

“Static mixer” means a mixer that does not comprise any moving components and that is standing still, i.e., that does not rotate about its central axis. For example, a static mixer as mentioned above is operable to intermix the components to be mixed by turning them over multiple times. Whereas, in contrast, a “dynamic mixer” has the characteristic of rotating or being rotatable about its central axis. For example, in this case, the mixer may be rotatably moved by means of the above-mentioned drive mechanism via the drive shaft.

The core element, the first blade element and the second blade element being “integrally formed” means that the core element, the first blade element and the second blade element form single common structural component. In particular, the core element, the first blade element and the second blade element may be formed from one material. “Formed from one material” here means that the core element, the first blade element and the second blade element are continuously formed from the same material. The mixer is preferably a one-piece plastic part. However, the mixer may also be a metal part, a ceramic part or a compound material part.

The first blade element height and the second blade element height being “different” means that the first blade element height is greater than the second blade element height or vice versa. It is however preferred that the second blade element height is greater than the first blade element height. The first blade element and the second blade element being arranged “immediately” adjacent, when viewed in a longitudinal direction in particular means that the first blade element is directly next to the second blade element. The term “adjacent” may also be substituted with the terms “behind each other”, “one above the other” or “in series”. “Immediately” means in particular that, when viewed in a longitudinal direction, no other elements or structural components are arranged between the first blade element and the second blade element. However, “immediately” does not preclude that a slight spacing may be provided between the first blade element and the second blade element. This spacing, however, is at most as large as the smaller of the two blade element heights. The longitudinal direction is oriented from a mixer base to a mixer tip of the mixer.

The first helix direction and the second helix direction being “different” means in particular that the first helix direction and the second helix direction are oppositely oriented. For example, the first helix direction has a left-handed or counter-clockwise orientation, when viewed in the longitudinal direction, and the second helix direction has a right-handed or clockwise orientation, when viewed in the longitudinal direction. The helix directions may also be reversed. This may be in particular the case where the mixer is dynamically operated, depending on a rotational direction of the mixer or on a rotational direction of the drive mechanism.

The first blade element preferably comprises two blade sections arranged in pairs and opposite each other, i.e. offset by 180°, at the core element. In particular, however, more than two blade sections may be provided. For example, three, four or five blade sections per blade element are provided. In the event that three blade section are provided, they may be arranged offset to each other at a circumferential angle of 120°. The two blade sections of the first blade element spiral about the core element in a double helix shape. The first blade element may also optionally have only one blade section. The second blade element also comprises two blade sections arranged at the core element offset relative to each other by 180°. The blade sections of the second blade element also spiral around the core element in a double helix shape. The second blade element may also optionally comprise only one blade section. In the case where the mixer is used in the static mixing operation, the blade elements act as guide blade elements or may be referred to as such. In the case where the mixer is used in the dynamic mixing operation, the blade elements act as moving blade elements or may be referred to as such.

According to an embodiment, the blade element feeding the product away from a mixer base of the mixer in a feed direction in the dynamic mixing operation of the mixer has the greater blade element height compared to the blade element feeding the product against the feed direction.

Preferably, the second blade element height is greater than the first blade element height. The mixer comprises, as mentioned above, the mixer tip in addition to the mixer base, wherein a mixing area of the mixer is provided between the mixer base and the mixer tip. The feed direction extends from the mixer base in the direction of the mixer tip. The feed direction preferably is the same as the longitudinal direction. The blade element feeding the product away in the feed direction of the mixer having the greater blade element height ensures that a pressure reduction in the mixer is achievable. This is because those blade elements that feed the product back or accumulate it are shorter than those blade elements that feed the product away from the mixer base. The mixer itself thus has a feeding effect. Moreover, in the dynamic mixing operation, a rotational direction of the mixer is operable to be reversed at the end of a dosing operation, so that the blade element, which has before fed the product in the feed direction, now pulls the product back against the feed direction. Thereby, reliably preventing dripping or pressing out. A second blade element configured, for example, as a feeding screw maybe provided.

According to another embodiment, in the dynamic mixing operation of the mixer, the first helix direction matches a rotational direction of the mixer, wherein the second helix direction is oriented against the rotational direction.

Preferably, the first helix direction has a left-handed or counter-clockwise orientation. The second helix direction preferably has a right-handed or clockwise orientation. The second helix direction being oriented against the rotational direction and the second blade element height being greater than the first blade element height ensures that the product is fed and mixed in the feed direction without significant pressure build-up. This prevents or at least minimizes dripping or pressing out. Low pressure build-up in the mixer also means less dripping or pressing out. Dripping and pressing out is the result of the product relaxing in the direction of the nozzle section.

According to another embodiment, the first blade element has a first pitch and the second blade element has a second pitch different from the first pitch, or the first blade element and the second blade element have an identical pitch.

“Pitch” or “thread pitch” here means a distance along the longitudinal direction that is covered by a complete turn of the respective blade element or the respective blade section. The pitch of the first blade element may, for example, be greater than the pitch of the second blade element or vice versa. Furthermore, the pitch of the first blade element and the pitch of the second blade element may also be the same size. Within one blade element, the blade sections may wind more or less than one complete turn around the core element.

According to another embodiment, the first blade element extends at least a quarter turn around the core element and/or the second blade element extends at least a complete turn around the core element.

This ensures that in the dynamic mixing operation the feeding effect of the second blade element in the feed direction is greater than the reverse turbulence against the feed direction by the first blade element. This prevents or at least reduces pressure build-up in the mixer.

According to another embodiment, a diameter of the core element is greater than a wall thickness of the first blade element and/or the second blade element.

The core element may have a round, in particular a circular, cross-section. However, the cross-section may also be polygonal, for example rectangular, or square, star-shaped, oval or elliptical. However, the cross-section may be designed completely arbitrarily. The cross-section may also be star-shaped.

According to another embodiment, when viewed along the longitudinal direction, a plurality of mixing stages is provided, each comprising a first blade element and a second blade element, wherein a ratio of the first blade element height to the second blade element height of a respective mixing stage is variable.

In particular, the ratio of the first blade element height to the second blade element height is ⅛ to ⅞, 2/8 to 6/8, ⅜ to ⅝, ⅝ to ⅜, 6/8 to 2/8 or ⅞ to ⅛. However, the ratio is arbitrarily selectable. Preferably, an even number of mixing stages is provided. For example, four, six, eight, ten or even more such mixing stages are provided. The mixing stages may be designed identical or different. The ratio of the blade element height may be arbitrarily defined. For example, the first blade element height may be 6.25 mm, 7.5 mm or 9.37 mm. The second blade element height may be, for example, 12.5 mm, 15.36 mm, 18.75 mm or 37.5 mm. However, the dimensions of the blade element heights are arbitrary and may be determined through experimentation and/or calculation depending on the product used and/or the use case.

According to another embodiment, the first blade element and/or the second blade element taper radially outward from the core element.

This allows for maximizing a cross-section of the mixer through which the components are passed or, respectively, through which the product is passed. As mentioned before, each blade element comprises preferably two blade sections. The blade sections are integrally connected to the core element by a spirally extending blade base. From the core element outward in a radial direction, the respective blade section of the blade elements comprises a blade tip spirally extending around the core element. A wall thickness of the respective blade element decreases from the blade base to the blade tip. The radial direction of the mixer is perpendicular to its central axis and oriented away from it. However, the wall thickness may also be constant.

According to another embodiment, the mixer is built in layers by means of a generative manufacturing method, in particular by means of a 3D printing process, or the mixer is produced by means of an injection molding process.

The generative manufacturing method may also be referred to as additive manufacturing method. With a generative manufacturing method, the structural component to be manufactured is build-up in layers, for example from a powder bed. The mixer may be produced by means of a selective laser melting process or a selective laser sintering process. However, any other suitable generative manufacturing method may be used. The mixer is preferably a one-piece plastic part. However, the mixer may also be made from a metal alloy or a ceramic material. There are virtually no limitations for the geometry of the mixer, and in particular the geometry of the blade elements, when a generative manufacturing method is used. This means that the mixer may be produced with a very complex geometry by means of the generative manufacturing method, whereas a production using classical manufacturing methods, such as plastic injection molding, is often only possible with increased effort due to the lack of demoldability. The use of the generative manufacturing method can be demonstrated microscopically by a layered structure of the mixer. Furthermore, when using the generative manufacturing method, the mixer has an increased roughness as compared to an injection-molded plastic part. This roughness may positively influence the mixing result. The mixer can be produced cost-effectively in large quantities through a plastic injection molding process. Thus, the use of a plastic injection molding process for producing the mixer may also be advantageous. However, most preferably, a generative manufacturing method is used.

According to another embodiment, when viewed in the longitudinal direction, the first blade element and the second blade element are arranged free of any spacing or are arranged spaced apart with a spacing of not more than 5 mm, preferably of not more than 4 mm, more preferably of not more than 3 mm, more preferably of not more than 2 mm, more preferably of not more than 1 mm, more preferably of not more than 0.5 mm, more preferably of not more than 0.25 mm, more preferably of not more than 0.1 mm.

The possible spacings indicated above fall in particular under the term “immediately” as explained above. However, most preferably, no spacing is provided between the first blade element and the second blade element. This means that the blade elements are most preferably arranged adjacent or neighboring free of any spacing or without any spacing. This means that the term “immediately” can be replaced by the terms “free of any spacing” or “without any spacing”.

According to another embodiment, when viewed in the longitudinal direction, an end edge of the first blade element is arranged at the same height as an end edge of the second blade element, or the first blade element runs into the second blade element such that the end edge of the first blade element and the end edge of the second blade element are arranged spaced apart by a projecting length, when viewed in the longitudinal direction.

In particular, the first blade element and the second blade element may be arranged such that, when viewed in the longitudinal direction, the first blade element overlaps the second blade element and vice versa. The blade elements “running into each other” means in particular that the blade elements overlap, when viewed in the longitudinal direction. In this case, the first blade element overlaps the second blade element by the projecting length and vice versa. This means that, viewed in the longitudinal direction, the end edges are arranged spaced apart by the projecting length. Preferably, each blade element is associated with a bottom or first end edge facing away from the mixer base and a top or second end edge facing the mixer base. For example, viewed with respect to the longitudinal direction, the first end edge of the first blade element is arranged at the same height as the second end edge of the subsequent second blade element or spaced apart from said second end edge by the projecting length. Furthermore, when viewed in the longitudinal direction, the first end edge of the second blade element is preferably positioned at the same height as the second end edge of the following first blade element or spaced apart from said first end edge by the projecting length. In the case described above, the blade elements are arranged free of any spacing or without any spacing.

According to another embodiment, the first blade element comprises two blade sections, three blade sections or more than three blade sections and/or the second blade element comprises two blade sections, three blade sections or more than three blade sections.

Thus the blade elements preferably each have multiple blades. In the case where the respective blade element comprises two blade sections, said blade sections are arranged at the core element offset by 180°. This means that the circumferential angle mentioned above is in particular 180°. In the case where the respective blade element comprises three blade sections, said blade sections are arranged at the core element offset by 120°. This means that the circumferential angle mentioned above is in particular 120°. In the case where four blade section per blade element are provided, the circumferential angle is 90°, correspondingly. However, more than four blade sections per blade element may also be provided.

According to another embodiment, the end edge of the first blade element and the end edge of the second blade element are oriented perpendicular to one another.

In the case, where the blade elements each comprise more than two blade sections, the end edges may also be oriented to one another at an angle other than 90°, for example at an angle of 120°. The two end edges may also be oriented to one another at any angle. The perpendicular arrangement of the end edges allows for optimal transfer of the components to be mixed from the first blade element to the second blade element and vice versa. This improves intermixing. In particular, a cross-section reduction in the feed direction can thereby be avoided.

According to another embodiment, the first blade element and/or the second blade element of the mixer are arcuately bent, in particular bent in a circular arc shape, when viewed in the radial direction of the mixer.

The blade sections of the blade elements in particular are arcuately bent or curved, in particular shaped in a circular arc. In particular, when viewed in the radial direction, the blade sections may tangentially merge with the core element. In this case, the blade sections preferably have a wall thickness tapering in the radial direction.

According to another embodiment, the mixer is a plastic part made from one material or a metal part made from one material.

As mentioned before, the mixer may also be made from a different material, such as from a ceramic material. Metallic materials can in particular be processed using selective laser melting (SLM). For example, stainless steel may be used as material for the mixer. One example for a metallic material is a stainless steel of material grade 1.4404. It is stainless, austenitic, acid-resistant and especially suitable for use in the food industry. A stainless steel of material grade 1.4542 may also be used. It is stainless, precipitation hardening and acid-resistant. Further, aluminum, such as the alloys AlSi12, AlSi10Mg or AlSi9Cu3, may also be used. Aluminum is a lightweight material able to withstand static and dynamic loads. Plastic materials can in particular be processed using selective laser sintering (SLS). For example, polyamide 12 (PA12) may be used. It has good mechanical properties, can be easily reworked and is biocompatible according to EN ISO 109931. PA12, in particular, is a suitable substitution material for conventional injection molding materials. In addition, PA12 is certified for food technology according to FDA and 21 CFR Section 177.1500 9(b), with the exception of alcoholic food products. Alumides (PA12 with aluminum content) may be used as another material group. Polyetheretherketone (PEEK) may also be used as a material for the mixer. PEEK is a high-performance polymer and belongs to the group of polyaryletherketones. PEEK is particularly suitable for use at high temperatures, resistant to chemicals, hydrolysis-resistant and sterilizable. All materials may also be fiber-filled, especially filled with aramid fibers, glass fibers or carbon fibers. Furthermore, the materials may be filled carbon nanotubes and/or be filled with spheres, in particular with glass spheres or plastic spheres.

Furthermore, a dosing device for dosing a liquid or paste-like product, in particular a multi-component product, is proposed. The dosing device comprises a first dosing pump for dosing a first component of the product, a second dosing pump for dosing a second component of the product, and said mixer for mixing the first component with the second component.

The mixer is in particular also suitable for mixing more than two components. The dosing pumps are preferably formed as progressive cavity pumps. However, the dosing pumps may also be gear pumps, piston pumps or the like. The first dosing pump and the second dosing pump may be arranged parallel to one another or in a V-shaped manner with respect to one another. For example, the dosing pumps are mounted on a flow block. Channels are passing through the flow block to the mixing device arranged at the front of the flow block. The components are feed through the channels to the mixer. The mixing device further comprises the above mentioned mixing tube and the mixer accommodated in the mixing tube. The mixing tube may be accommodated in a support tube preventing said mixing tube to bulge. The mixing tube may comprise a nozzle section for dosing the product.

According to an embodiment, the dosing device further comprises a drive mechanism adapted for rotating the mixer about its central axis to dynamically mix the first component and the second component.

The drive mechanism may be arranged between the two dosing pumps. The drive mechanism may also be positioned at any location. The drive mechanism further comprises, as mentioned above, a drive shaft coupled with the mixer. For this purpose, the mixer may have an interface by means of which said mixer is coupleable with the drive shaft. The interface may be, for example, a circular boring provided in the mixer base. The interface may also be an internal thread provided on the core element. In this case, the drive shaft has a corresponding external thread. This allows for quick coupling of the mixer to the drive shaft as well as quick decoupling of the mixer from the drive shaft. The interface may also be embodied as tenon and mortise. The interface may also comprise a clip connection. This allows for the mixer to be mounted on and removed from the drive shaft particularly easily and quickly.

Other possible implementations of the invention also comprise combinations of features or embodiments that are not explicitly mentioned above or described below in the context of the exemplary embodiments. The person skilled in the art will also add individual aspects as improvements or additions to the respective basic form of the invention.

Further advantageous designs and aspects of the invention are subject of the dependent claims as well as the exemplary embodiments of the invention described below. Furthermore, the invention is explained in more detail on the basis of preferred embodiments with reference to the enclosed figures.

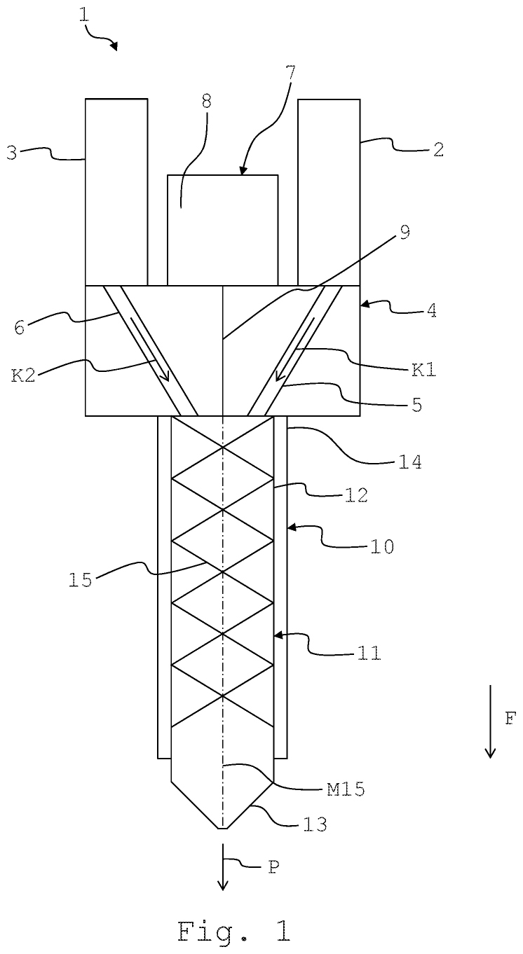

FIG. 1 shows a schematic view of an embodiment of a dosing device;

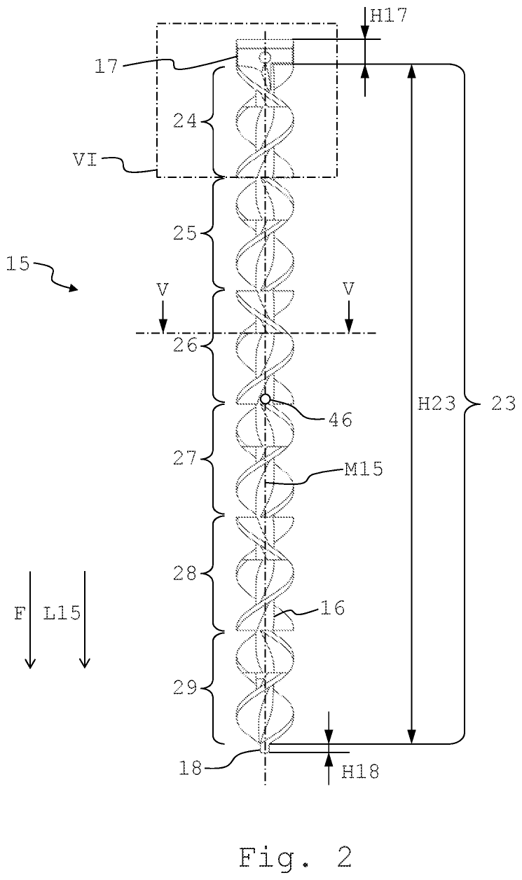

FIG. 2 shows a schematic view of an embodiment of a mixer for the dosing device according to FIG. 1;

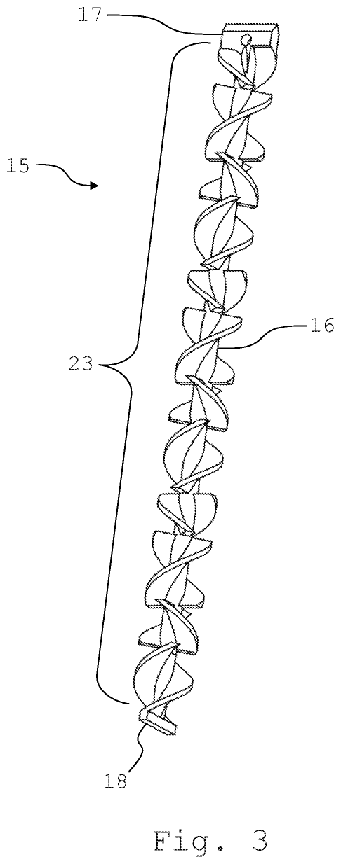

FIG. 3 shows a schematic perspective view of the mixer according to FIG. 2;

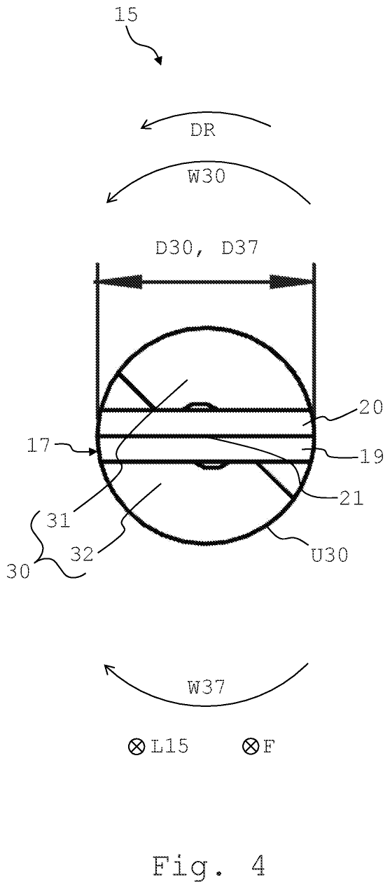

FIG. 4 shows a schematic top plan view of the mixer according to FIG. 2;

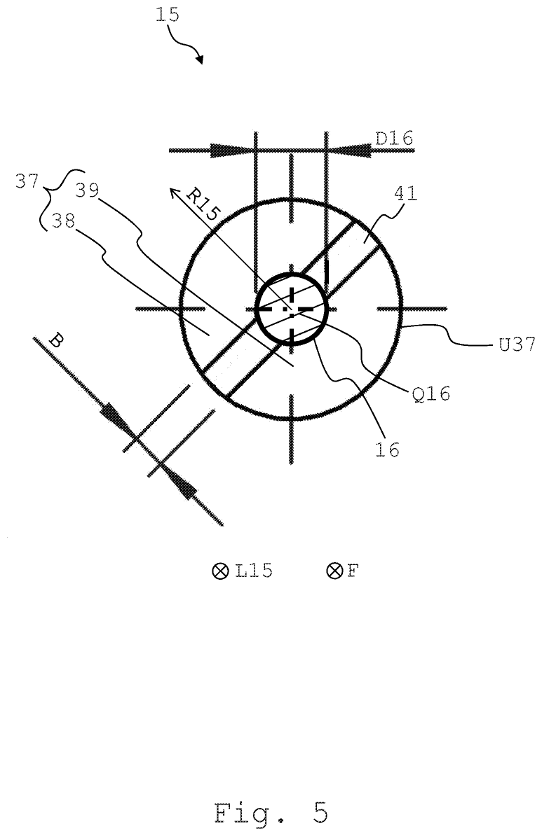

FIG. 5 shows a schematic sectional view of the mixer according to section V-V of FIG. 2;

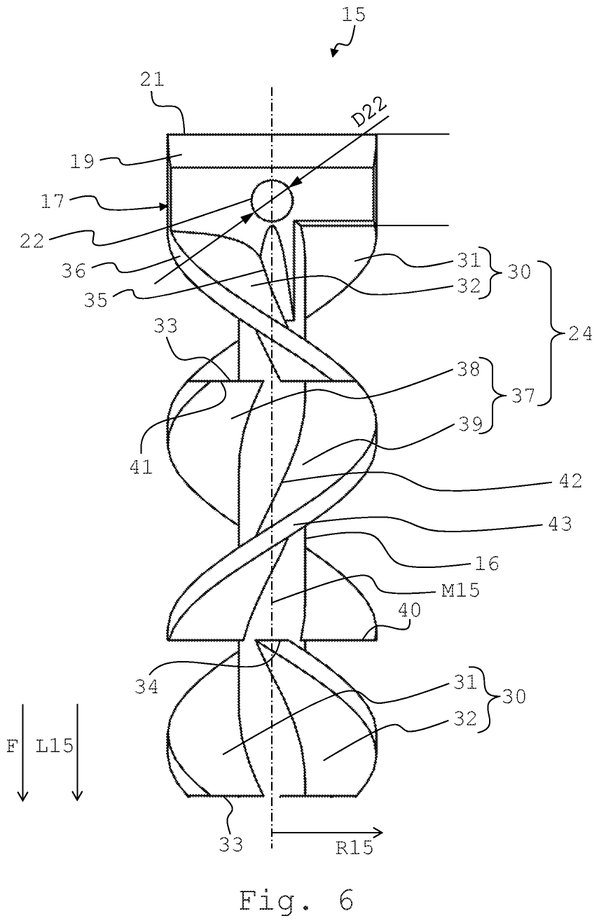

FIG. 6 shows the detail view VI according to FIG. 2;

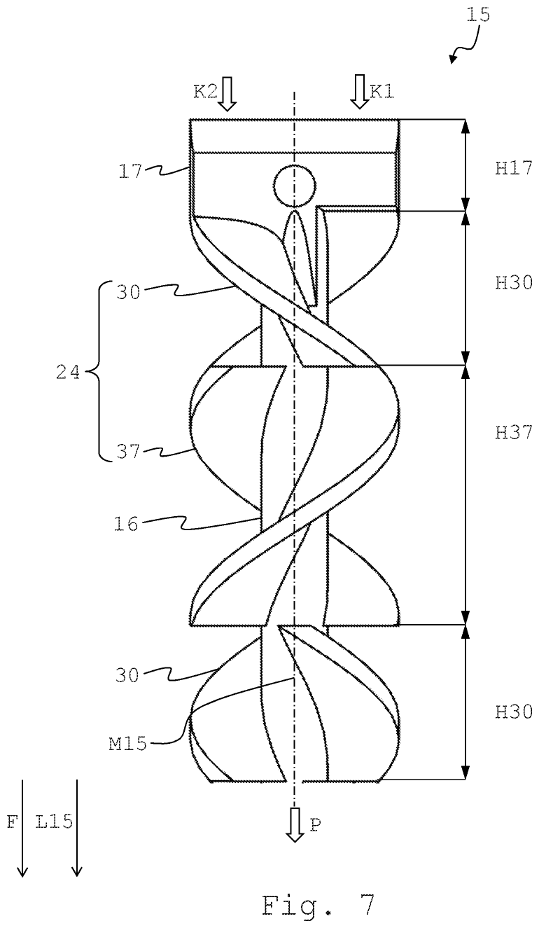

FIG. 7 shows again the detail view VI according to FIG. 2;

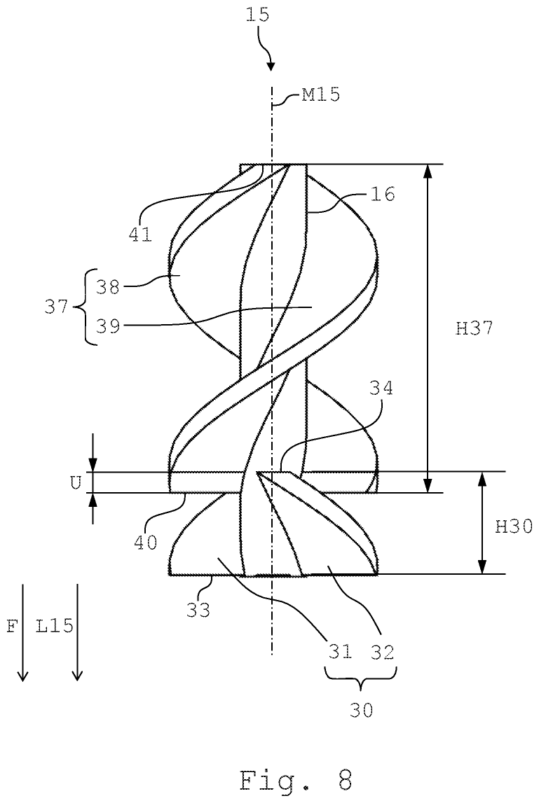

FIG. 8 shows a schematic partial view of another embodiment of a mixer for the dosing device according to FIG. 1;

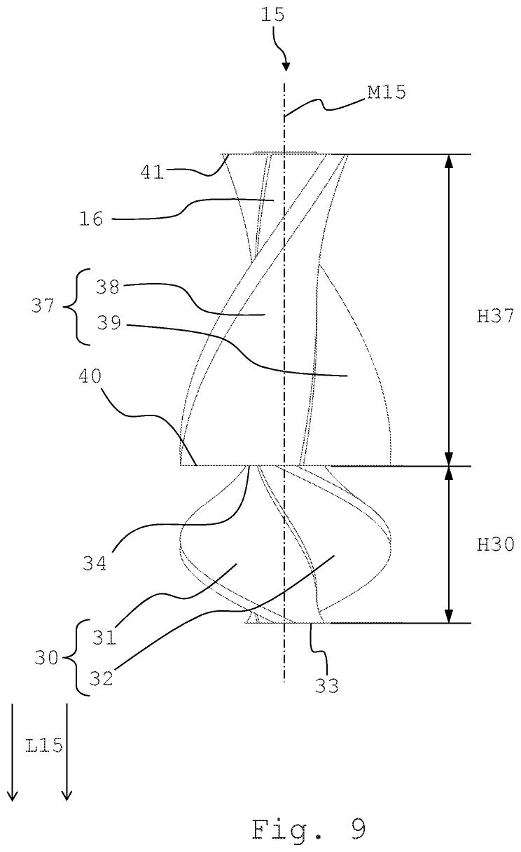

FIG. 9 shows a schematic partial view of another embodiment of a mixer for the dosing device according to FIG. 1;

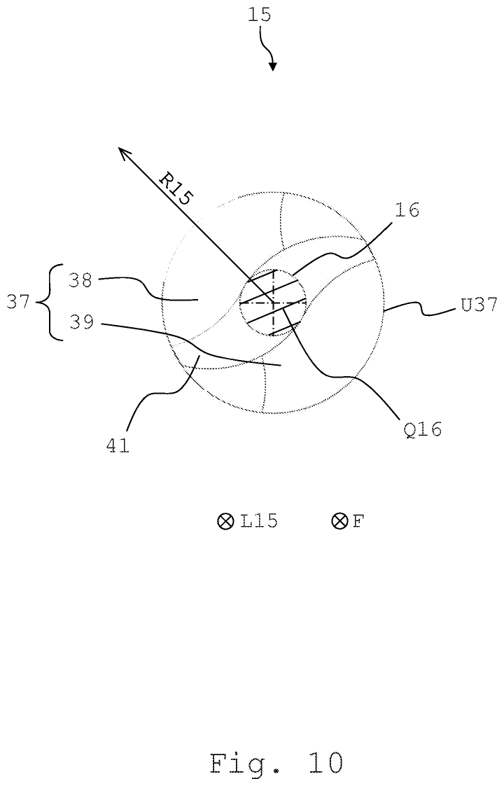

FIG. 10 shows a schematic top plan view of the mixer according to FIG. 9;

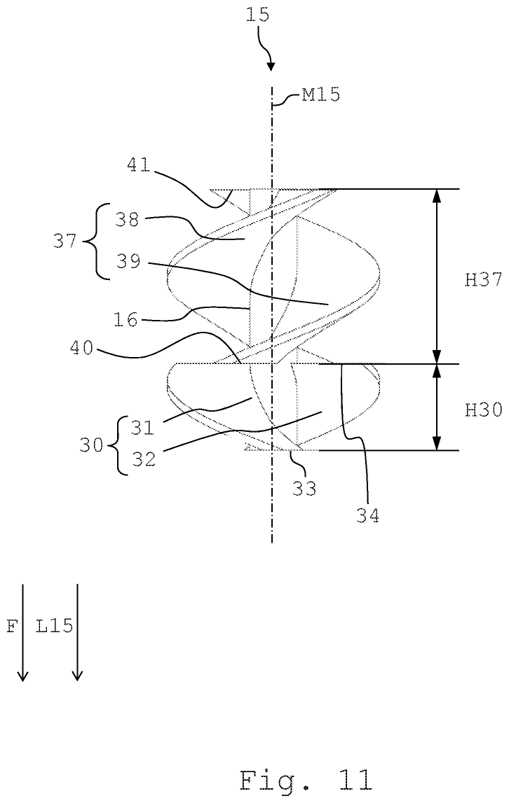

FIG. 11 shows a schematic partial view of another embodiment of a mixer for the dosing device according to FIG. 1;

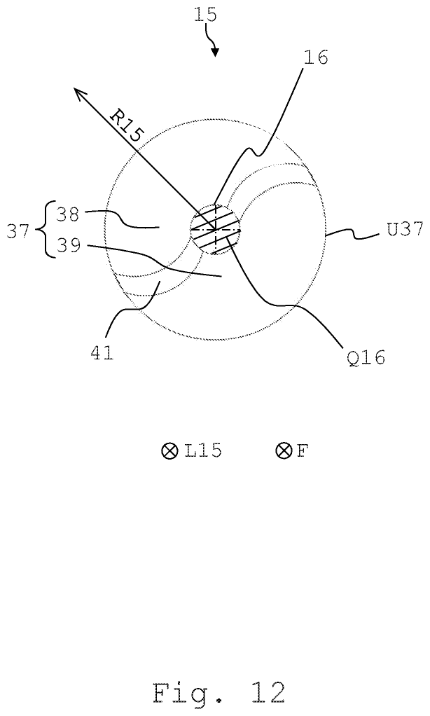

FIG. 12 shows a schematic top plan view of the mixer according to FIG. 11;

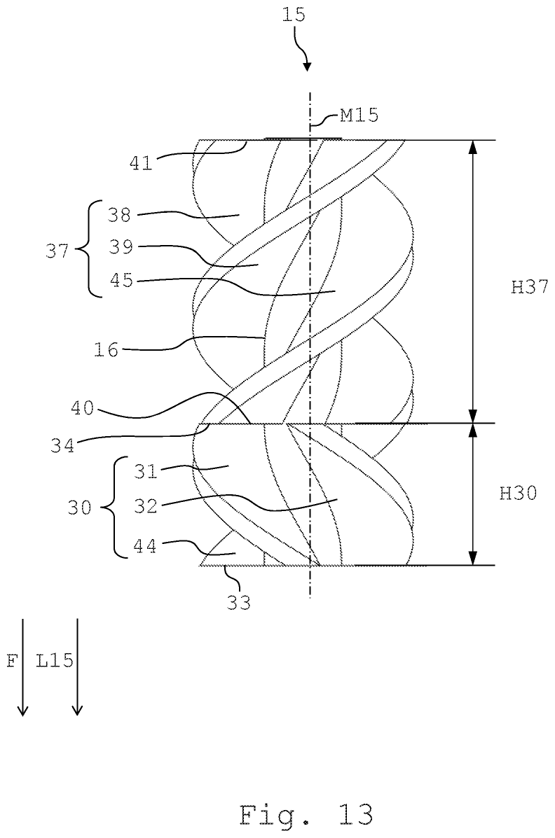

FIG. 13 shows a schematic partial view of another embodiment of a mixer for the dosing device according to FIG. 1;

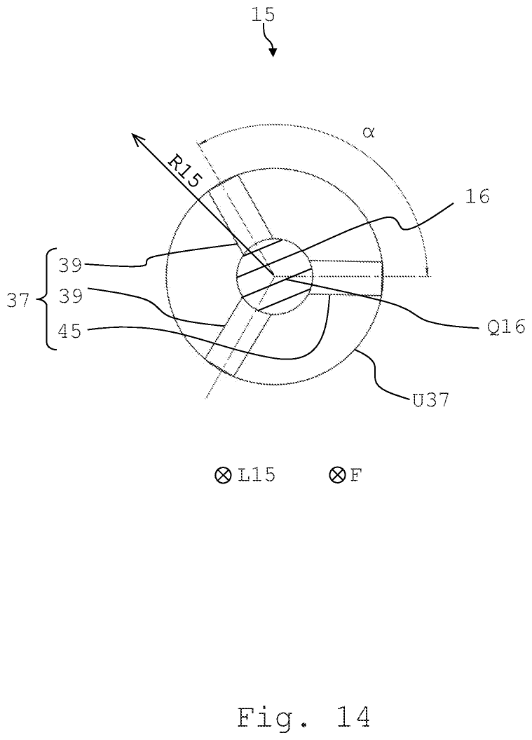

FIG. 14 shows a schematic top plan view of the mixer according to FIG. 13;

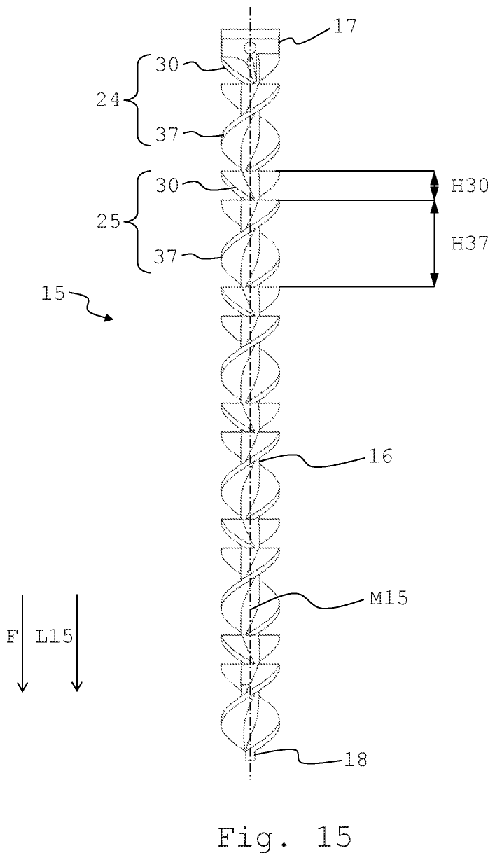

FIG. 15 shows a schematic view of another embodiment of a mixer for the dosing device according to FIG. 1;

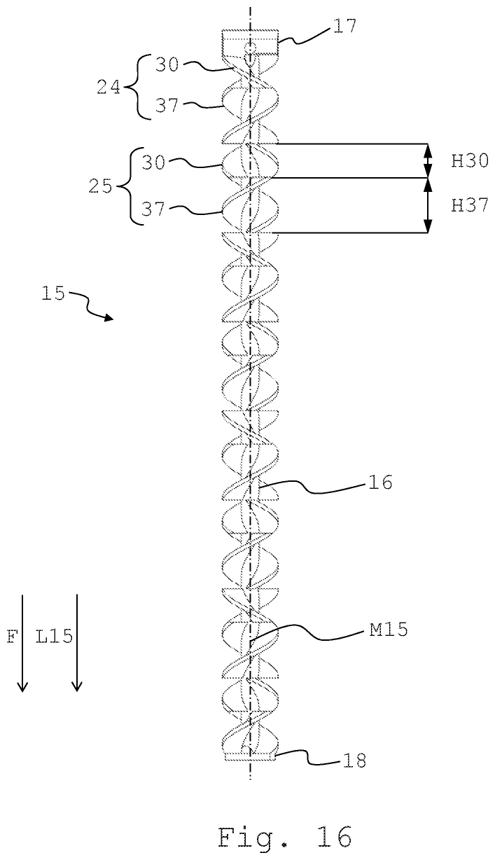

FIG. 16 shows a schematic view of another embodiment of a mixer for the dosing device according to FIG. 1;

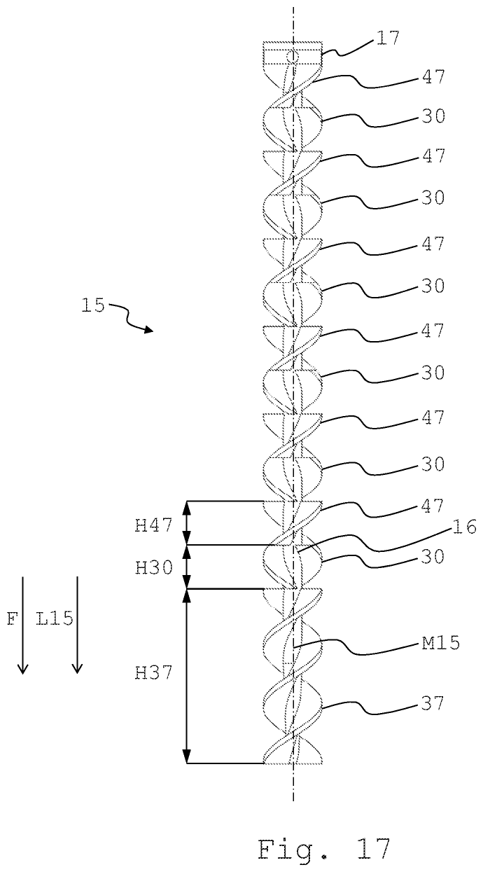

FIG. 17 shows a schematic view of another embodiment of a mixer for the dosing device according to FIG. 1; and

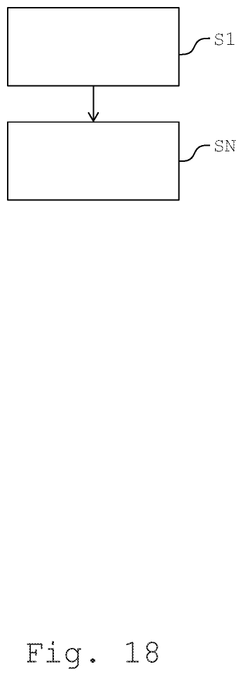

FIG. 18 shows a schematic block diagram of an embodiment of a method for manufacturing the mixer according to FIG. 2, FIG. 8, FIG. 9, FIG. 11, FIG. 13, FIG. 15, FIG. 16 and FIG. 17.

In the figures, identical or functionally identical elements have been provided with the same reference numbers, unless otherwise indicated.

FIG. 1 shows a highly simplified schematic view of an embodiment of a dosing device 1 for dosing a liquid or paste-like product P. The product P may, for example, be an adhesive and/or a sealant, in particular a multi-component adhesive and/or a sealant, water, an aqueous solution, a paint, a varnish, a suspension, a viscous raw material, an emulsion, a grease or the like. For example, the product P may be a two-component adhesive. “Paste-like” product P or “paste” means a solid-liquid mixture, in particular a suspension with a high content of solids.

The product P may comprise one or more than one component K1, K2, in particular a first component K1 and a second component K2. The components K1, K2 may be liquid or paste-like. Furthermore, one of the components K1, K2 may also be a solid, in particular a filler, or comprise a solid. The components K1, K2 and the product P are in particular fluids. “Fluid” here means a flowable material in its broadest sense, meaning, not only liquid or paste-like, but also granular, such as hollow glass spheres, or any mixture or even a mixture that is inhomogeneous in particle size and/or material. The components K1, K2 may also be pairings of any kind of different fluids, so, just as an example, a liquid and a granular component.

The product P may be, as mentioned above, filled with fillers, for example. Particularly suitable fillers used are microballoons. Microballoons are hollow polymer spheres or hollow glass spheres that are being used, for example, as fillers for epoxy and polyester resin systems as well as for polysulfides and polyether systems. This can result in weight reduction and/or thickening of the product P. Such microballoons in the form of hollow glass sphere may, for example, have a bulk density of 140 g/l to 150 g/l, a specific weight of 0.26 g/cm³, a particle size distribution of 50 μm and a maximum particle size of 200 μm. Microballoons are, in particular in a range of 0 bar to 15 bar, compressible. This means that, when the product P is filled with microballoons, said product may be compressible or have compressible characteristics. Hollow glass spheres are hard and burst at a certain pressure. Hollow polymer spheres are deformable and as such compressible. Hollow glass spheres, too, may be compressible at least to a certain extent.

“Compressible” may mean that the product P is practically or substantially compressible. “Incompressible” may further mean that the product P is practically or substantially incompressible. For example, the product P may show a compressibility (volume change) of about 20% at a pressure of about 15 bar. In a range from 15 bar to 30 bar, compressibility (volume change) may be characterized as virtually incompressible as compared to a lower pressure range of 0 bar to 15 bar. Above 30 bar, the product P may then be compressible again, since the microballoons may burst or collapse. In particular with hollow plastic spheres, the microballoons may be damaged, for example pressed in, such that a permanently changed volume and/or weight occurs.

A fluid whose density is not depended on pressure is called incompressible—in contrast to compressible fluids. One property of fluids is compressibility, which describes the change in density of a fluid with pressure change and the property of volume change with temperature change. The compressibility of a fluid is the decision criterion with regard to a distinction between gas (compressible) and liquid (almost incompressible). The terms hydraulics (almost incompressible fluids such as liquids, mostly oil) and pneumatics (compressible fluids such as gases, mostly air) refer to techniques that realize and control “force” with fluids. A further distinction is made between perfect fluids and real fluids.

The dosing device 1 comprises at least one dosing pump 2, 3. The dosing device 1 may, as shown in FIG. 1, comprise two dosing pumps 2, 3, in particular a first dosing pump 2 and a second dosing pump 3, or any number of dosing pumps 2, 3, such as three dosing pumps. The dosing pumps 2, 3 may be, for example, progressive cavity pumps, gear pumps, piston dispensers or the like. The dosing pumps 2, 3 are preferably embodied as progressive cavity pumps.

A progressive cavity pump preferably comprises a stator accommodated in a pump housing and comprising a resiliently deformable elastomeric member having a center aperture. The aperture preferably comprises a screw-shaped or helical internal contour. A rotatable rotor comprising a screw-shaped or helical external contour corresponding to the elastomeric member is preferably provided in the stator. The rotor may be driven by a drive member, in particular an electric motor, via a drive shaft.

The drive shaft may be fixedly connected to the rotor by means of a flexible shaft, a flex shaft or a universal shaft. When the rotor is rotated, the product P or the respective components K1, K2 is fed away from the drive shaft in a feed direction F of the dosing pump 2, 3 using the endless piston principle through the interaction with the elastomeric member of the stator. The feed volume depends on the speed, size, pitch and geometry of the rotor.

The first dosing pump 2 is operable to dose the first component K1. The second dosing pump 3 is operable to dose the second component K2. The volumetric flow rates of the two-component K1, K2 may be different. The dosing pumps 2, 3 are mounted on a flow block 4. The dosing pumps 2, 3 are preferably arranged parallel to one another. Alternatively, the dosing pumps 2, 3 may also be positioned in a V-shaped manner with respect to one another.

The flow block 4 may, for example, be made from a steel or an aluminum material. The flow block 4 may be made of several parts. In the flow block 4 a first channel 5 is provided, through which the first component K1 may be passed. The flow block 4 further comprises a second channel 6, through which the second component K2 may be passed. The channels 5, 6 may be positioned in a V-shaped manner relative to one another, as shown in FIG. 1. Alternatively, the channels 5, 6 may also be positioned parallel to one another or sectionally parallel to one another. In the flow block 4, pressure sensors for detecting a respective pressure of the components K1, K2 may be integrated in the channels 5, 6.

Further provided on the flow block 4 is a drive mechanism 7. The drive mechanism 7 may comprise an electric motor, for example. The drive mechanism 7 may be arranged between the two dosing pumps 2, 3, as shown in FIG. 1. Alternatively, the drive mechanism 7 may be mounted at any location on the flow block 4. The drive mechanism 7 comprises a drive member 8, such as an electric motor, and a drive shaft 9 passing through the flow block 4 and extending between the channels 5, 6. The drive member is operable to drive the drive shaft 9. However, the drive mechanism 7 is optional.

Facing away from the dosing pumps 2, 3, a mixing device 10 is disposed on the flow block 4. The mixing device 10 may be mounted directly to the flow block 4. However, additional structural components (not shown) may be provided between the flow block 4 and the mixing device 10. The mixing device 10 is operable to mix the first component K1 and the second component K2 into product P.

The mixing device 10 comprises a mixing tube 11 adapted to be connected to the flow lock 4 by means of a union nut (not shown), for example. The mixing tube 11 preferably is a plastic part, in particular an injection-molded plastic component. The mixing tube 11 may be a disposable part. For example, the mixing tube 11 may be disposed of after one-time use or after a predetermined period. The mixing tube 11 comprises a hollow cylinder-shaped base section 12 and a nozzle section 13 facing away from the flow block 4 and which may be embodied frustoconically.

The base section 12 and the nozzle section 13 are integrally formed, in particular are made of one material. “Integrally” here means that the base section 12 and the nozzle section 13 form a common structural component, such as in the form of an injection-molded plastic component. “Made from one material” here means that the base section 12 and the nozzle section 13 are made from the same material throughout. The nozzle section 13 is operable to apply the product P. For this purpose, the dosing device 1 is may be positioned by means of a robot, for example. The mixing tube 11 may be accommodated in a stabilizing support tube 14. The support tube 14 may be a steel tube, for example. The support tube 14 prevents the base section 12 of the mixing tube 11 from bulging, when pressure is applied to said mixing tube 11.

A mixer 15 is accommodated in the mixing tube 11. The mixer 15 may also be referred to as helical mixer panel, mixing helix, mixer insert or mixing insert. The mixer 15 may be either a static mixer or a dynamic mixer. “Static mixer” here means a mixer that does not comprise any moving parts and that is not rotating but standing still relative to the mixing tube 11. Such a static mixer comprises in particular mixing members or mixing elements, wherein the two components K1, K2 are intermixed by being turned over multiple times while they are fed through the mixing device 10.

With this principle the two components K1, K2 are intermixed by repeated re-layering of the components K1, K2. To achieve a high-quality mixture, various parameters may be dimensioned differently in such a mixer 15. For example, the geometry of the mixing members, the number of mixing members and a diameter of the mixer 15 may be dimensioned. In such static mixers, a laminar flow can generally be assumed for fluids with medium to high viscosities.

In contrast to this, a “dynamic mixer” comprises a drive such as in the form of the drive mechanism 7. The drive member 8 is coupled by means of the drive shaft 9 to the mixer 15 such that the mixer 15 is rotatable in the mixing tube 11 about an axis of symmetry or central axis M15 of the mixer 15.

When feeding the components K1, K2 or the product P through the mixing device 10, a pressure acting on the product P builds up in the mixing tube 11 due to the flow resistance of the mixer 15, while the product P is dosed by means of the dosing pumps 2, 3. In mixers as described in the introduction, this pressure drops approximately linearly from the flow block 4 in the direction of the nozzle section 13. Because the product P is compressible within a certain pressure range when filled with microballoons, the microballoons may expand and thus the product P may be pressed out of the nozzle section 13, when the dosing process is stopped, i.e. when the dosing pumps 2, 3, are standing still.

This pressing out of the product P may cause the formation of droplets on the nozzle section 13, which is undesirable since the formation of droplets may cause blobs to form either at the end of a product bead just placed or at the beginning of subsequent placement of a product bead. Thus the components K1, K2 must advantageously mixed such that the pressure applied in the mixing device 10 to the product P, which is filled with fillers, is as low as possible.

FIG. 2 shows a schematic side view of an embodiment of a mixer 15 for the mixing device 10. FIG. 3 shows a schematic perspective view of the mixer 15. FIG. 4 shows a schematic top plan view of the mixer 15, FIG. 5 shows a schematic sectional view of the mixer 15 according to section V-V of FIG. 2 and FIGS. 6 and 7 both show the detail view VI according to FIG. 2. In the following, reference is made simultaneously to FIGS. 2 to 7.

The mixer 15 is a monolithic structural component, in particular a structural component that is made from one material. The mixer 15 may be made of a plastic material, a ceramic material, a metal material or a composite material. The mixer 15 is preferably produced by means of a generative or an additive manufacturing method. Compared to a plastic injection molding process, for example, this allows for various degrees of freedom in the structural design of the mixer 15. The mixer 15 is preferably produced by means of a 3D printing process.

A 3D printing process is a method in which material such as plastic powder is applied layer by layer, thus producing the three-dimensional geometry of the mixer 15. Typical materials for 3D printing processes are plastic, synthetic resins, ceramics and metals. Thus a layered structure can be demonstrated microscopically for the mixer 15. Furthermore, the mixer 15 comprises a rougher surface as compared to an injection-molded plastic part. The rougher surface may be advantageous when intermixing the components K1, K2.

The mixer 15 comprises a core element 16. The core element 16 is preferably constructed rotationally symmetrical to the central axis M15. For example, the core element 16 has a circular cross-section Q16. The cross-section Q16 is shown hatched in FIG. 5. However, the cross-section Q16 may have any geometry. For example, the cross-section Q16 may be oval, ellipsoidal, polygonal, in particular square or triangular, star-shaped or diamond-shaped. The core element 16 preferably has a diameter D16 (FIG. 5). The diameter D16 may be 4 mm, for example. However, the diameter D16 may take on any value.

The mixer 15 comprises a mixer base 17 and a mixer tip 18. A longitudinal direction L15 of the mixer 15 is oriented from the mixer base 17 in the direction of the mixer tip 18. The longitudinal direction L15 is oriented parallel to the central axis M15 or coincides with said central axis. The longitudinal direction L15 coincides with the feed direction F of the product P or the components K1, K2 along the mixer 15. The mixer 15 is also associated with a radial direction R15 (FIGS. 5 and 6). The radial direction R15 is oriented perpendicular to the central axis M15 and points away from the central axis M15.

The mixer base 17 is constructed cuboid and extents over two obliquely arranged side faces 19, 20 toward a chisel-shaped tip 21. The mixer base 17 further comprises an interface 22 operable to connect the mixer 15 with the drive shaft 9 of the drive mechanism 7. The interface 22 may be a circular aperture, in particular a boring, completely penetrating through the mixer base 17. The interface 22 may have a diameter D22. The diameter D22 may be 2.5 mm. However, the diameter D2 may take on any value.

Accordingly, the drive shaft 9 may comprise an engaging portion, in particular a hook, engaging the interface 22 or being hooked into said engaging portion. This allows for quick coupling of the mixer 15 to the drive shaft 9. Alternatively, the interface 22 may also have any geometry that makes it possible to connect the mixer 15 quickly and easily to the drive shaft 9 in a detachable manner. For example, the interface 22 may be an internal thread extending along the central axis M15. Accordingly, the drive shaft 9 may comprise a corresponding external thread. In this case, the mixer 15 may simply be screwed onto the drive shaft 9. The interface 22 may also be embodied in the shape of a tenon, a mortise or a clip connection.

The mixer base has a height H17, when viewed along the longitudinal direction L15. The height H17 may be 5.5 mm, for example. However, the height H17 may take on any value. The mixer tip 18 is preferably cuboid or bar-shaped. The mixer tip 18 is arranged perpendicular to the central axis M15. The mixer tip 18 may have a height H18, when viewed along the longitudinal direction L15. The height H18 may be 2 mm, for example. However, the height H18 may take on any value. The height H18 may also be zero so that there is no mixer tip 18 at all. This means that the mixer tip 18 is expendable.

A mixing area 23 of the mixer 15 is provided between the mixer base 17 and the mixer tip 18. The mixing area 23 is operable to mix the components K1, K2 to turn them into the product P. The mixing area 23 comprises a height H23, when viewed in the longitudinal direction L15. The height H23 may be 150 mm, for example. However, the height H23 may take on any value. The mixing area 23 is divided into a plurality of mixing stages 24 to 29. The number of the mixing stages 24 to 29 is arbitrary. For example, as seen is FIGS. 2 and 3, six mixing stages 24 to 29 are provided. In particular, a first mixing stage 24 to a sixth mixing stage 29 are provided. However, more or less than six mixing stages 24 to 29 may be provided. Preferably, the number of the mixing stages 24 to 29 is an even number. For example, four, six, eight, ten or more than ten mixing stages 24 to 29 are provided.

Each mixing stage 24 to 29 comprises a first blade element 30 with a first helix direction W30 (FIG. 4). The first blade element 30 is integrally formed with the core element 16 and extends screw-like or spirally around the core element 16. The first blade element 30 is a guide blade element or may be referred to as such, in the case where the mixer 15 is a static mixer. In the case where the mixer 15 is a dynamic mixer, the first blade element 30 is a moving blade element or may be referred to as such. The first blade element 30 may also be referred to as first mixing member or first mixing blade.

Each first blade element 30 comprises a first blade section 31 and a second blade section 32. The two blade sections 31, 32 are integrally formed with the core element 16 offset relative to each other by 180°. The two blade sections 31, 32 have the same first helix direction W30. This means that the first blade element 30 winds around the core element 16 with the blade section 31, 32 in a double helix shape or double spiral shape.

The first blade element 30 has a diameter D30 at its outer circumference U30 (FIG. 4). The diameter D30 may be 12.6 mm, for example. However, the diameter D30 may take on any value. The first blade element 30 or the blade sections 31, 32 of the first blade element 30 comprises or comprise, respectively, two end edges 33, 34 spaced apart in the longitudinal direction L15 and arranged parallel to one another. However, the first blade element 30 immediately following the mixer base 17 in FIG. 6 comprises only one such end edge 33. The end edges 33, 34 are positioned rotated relative to one another. In particular, the end edges 33, 34 are oriented perpendicular to one another. End edge 33 may be referred to as bottom or first end edge, and end edge 34 may be referred to as top or second end edge.

The respective first blade element 30 of each mixing stage 24 to 29 has a first blade element height H30. The first blade element height H30 may be 9.37 mm, for example. However, the first blade element height H30 may take on any value. The first blade element height H30 is in particular defined as a distance of the end edges 33, 34 of a respective first blade element 30 from one another, when viewed in the longitudinal direction L15.

Each blade section 31, 32 of each first blade element 30 comprises a blade base 35 by means of which the respective blade section 31, 32 is integrally connected to the core element 16, and a blade tip 36 arranged spaced apart from the blade base 35 in the radial direction R15. The blade sections 31, 32 may taper from the blade base 35 in the direction of the blade tip 36, when viewed in the radial direction R15. This means that a wall thickness of the respective blade element 30 or the blade sections 31, 32, respectively, decreases in the radial direction R15. However, the wall thickness may also be constant.

Each mixing stage 24 to 29 is associated with a second blade element 37 separate from the first blade element 30. The second blade element 37 being “separate” from the first blade element 30 here means in particular that the second blade element 37 and the first blade element 30 are to separate structural components or members of the mixer 15, which in particular do not contact or touch each another. In particular, the blade elements 30, 37 are only in connection with each other via the core element 16. The first blade element 30 and the second blade element 37 of each mixing stage 24 to 29 are positioned adjacent or neighboring, when viewed in the longitudinal direction L15. The second blade element 37 may also be referred to as second mixing member or second mixing blade.

The second blade element 37 extends screw-like or spirally in a second helix direction W37 that is different that is different from the first helix direction W30 (FIG. 4) around the core element 16. The second blade element 37 is also integrally formed with the core element 16. Like the first blade element 30, the second blade element 37 comprises two blade sections 38, 39, in particular a first blade section 38 and a second blade section 39. The blade sections 38, 39 extend around the core element 16 in a double spiral shape or double helix shape. In the case where the mixer 15 is a static mixer, the second blade element 37 is a guide blade element or may be referred to as such. In the case where the mixer 15 is a dynamic mixer, the second blade element 37 is a moving blade element or may be referred to as such.

The second blade element 37 has a diameter D37 (FIG. 4) at its outer circumference U37 (FIG. 5). The diameter D37 is preferably equal to the diameter D30. The second blade element 37 comprises two end edges 40, 41 spaced apart and arranged parallel to one another. The end edges 40, 41 are arranged perpendicular to the central axis M15. The end edges 40, 41 are preferably rotated relative to one another. In particular, the end edges 40, 41 are oriented perpendicular to one another. The end edges 33, 34, 40, 41 have a width B (FIG. 5). The width B may be 2 mm. However, the width B may have any other value. End edge 40 may be referred to as bottom or first end edge, and end edge 41 may be referred to as top or second end edge.

The respective second blade element 37 of each mixing stage 24 to 29 has a second blade element height H37. The second blade element height H37 may be 15.63 mm, for example. However, the second blade element height H37 may take on any value. The second blade element height H37 is in particular defined as a distance of the end edges 40, 41 of a respective second blade element 37 from one another, when viewed in the longitudinal direction L15.

The first blade elements 30 and second blade elements 37 are alternately arranged in the mixing area 23 such that always one first blade element 30 is arranged between two second blade elements 37 and one second blade element 37 between two first blade elements 30. However, this does not apply to the first blade element 30 shown at the very top in FIGS. 6 and 7, adjoining the mixer base 17, and also not to the second blade element 37 shown at the very bottom in FIGS. 2 and 3, adjoining the mixer tip 18.

The blade sections 38, 39 of the second blade element 37 each comprises a blade base 42 by means of which the respective blade section 38, 39 is integrally connected to the core element 16, and a blade tip 43 arranged spaced apart from the blade base 42 in the radial direction R15. A wall thickness of the second blade element 37 or the blade section 38, 39, respectively, tapers in the radial direction R15 from the blade base 42 in the direction of the blade tip 43. This means that a wall thickness decreases, when viewed in the radial direction R15. However, the wall thickness may also be constant.

As shown in FIG. 4, the first helix direction W30 has a left-handed or counter-clockwise orientation, and the second helix direction has a right-handed or clockwise orientation. The helix directions W30, W37 may also be reversed. However, the helix directions W30, W37 are always oppositely oriented. This means that the first blade element 30 and the second blade element 37 of each mixing stage 24 to 29 are different from one another in their helix direction W30, W37.

However, the first blade element 30 and the second blade element 37 are not only different in their helix direction W30, W37, but also in that the blade elements 30, 37 have different blade element heights H30, H37, when viewed in the longitudinal direction L15. As mentioned above, the first blade element height H30 may be 9.37 mm, for example. As mentioned above, the second blade element height H37 may be 15.63 mm, for example. This means that the second blade element height H37 is greater than the first blade element height H30. Vice versa, the first blade element height H30 may also be greater than the second blade element height H37.

Thus, within each mixing stage 24 to 29 a height ratio of the blade elements 30, 37 may be specified, wherein each mixing stage 24 to 29 along the longitudinal direction L15 can be divided into eight eighths. Thus, with the dimensions of the blade element heights H30, H37, a dividing ratio, stage ratio or ratio of the first blade element height H30 to the second blade element height H37 or a blade element height ratio of ⅜ to ⅝ results. However, the blade element height ratio may also be ⅛ to ⅞, 2/8 to 6/8, ⅝ to ⅜, 6/8 to 2/8 or ⅞ to ⅛. The ratio of the blade element heights H30, H37 is thus adjustable to the pertinent use case of the mixer 15 over a large range.

In addition to the different helix directions W30, W37 and the different blade element heights H30, H37, the blade elements 30, 37 may also be different from one another in their pitch. “Pitch” or “thread pitch” here means a distance along the longitudinal direction L15 that is covered by a complete turn or 360° turn of the respective blade element 30, 37. In the embodiment of the mixer 15 shown in FIGS. 2 to 7, however, the blade elements 30, 37 have identical pitches.

As FIGS. 2, 3, 6, and 7 show, the first blade elements 30 and the second blade elements 37 are positioned immediately adjacent or neighboring, when viewed in the longitudinal direction L15. “Immediately” may here mean that, when viewed in the longitudinal direction L15, a respective bottom end edge 33 of a first blade element 30 is arranged at the same height as a respective top end edge 41 of an adjacent second blade element 37. Accordingly, a top end edge 34 of another first blade element 30 is also on the same height as a bottom end edge 40 of the adjacent second blade element 37, when viewed in the longitudinal direction L15.

Thus the blade elements 30, 37 preferably extend around the core element 16 such that, when viewed in the longitudinal direction L15, no areas of the core element 16 are free from blade elements 30, 37. This means that “immediately” may mean that the blade elements 30, 37 are arranged free of any spacing or without any spacing, or free of any gaps or without any gap.

However, “immediately” may also mean that between the respective end edges 33, 41 or 34, 40, when viewed in the longitudinal direction L15, a slight spacing (not shown) may be provided. This spacing, however, is preferably less than the smaller blade element height H30, H37 of the two blade elements 30, 37. For example, the spacing is less than 5 mm, more preferably less than 4 mm, more preferably less than 3 mm, more preferably less than 2 mm, more preferably less than 1 mm, more preferably less than 0.5 mm, more preferably less than 0.4 mm, more preferably less than 0.3 mm, more preferably less than 0.2 mm, more preferably less than 0.1 mm. However, the spacing most preferably equals zero, a explained above. This means that the blade elements 30, 37 most preferably are adjacent to each other without any spacing, preferably, however, without contacting one another (FIG. 6).

The mixer 15 may further comprise a marking member 46 (FIG. 2). The marking member 46 may be a steel pin or a steel bolt, for example. For example, the marking member 46 may be arranged roughly between the mixing stages 26, 27. The marking member 46 may, for example, be melted into the mixer 15 or adhered to it. The mixer 15 may also be constructed in layers around the marking member 46. In a dynamic operation of the mixer 15, the marking member 46 may be used to check whether the marking member 46 rotates with the core element 16 or not during a mixing operation by means of a suitable sensor. In the event the marking member 46 no longer rotates with the core element, it can be assumed that the core element 16 is broken or sheared off. The mixer 15 can then be replaced.

The functionality of the mixing device 10 of the mixer 15 is explained below. In the case where the mixer 15 is a static mixer, the mixer 15 stands still in the mixing tube 11 and does not rotate about the central axis M15. During operation of the dosing device 1, the dosing pumps 2, 3, feed the components K1, K2 in the feed direction F along the mixer 15. The two components K1, K2 first reach the mixer base 17. Due to the mixer base 17 being embodied roof-shaped and having a chisel-shaped tip 21, an accumulation of the components K1, K2 directly at the mixer base 17 is prevented.

The components K1, K2 reach the first blade element 30 of the first mixing stage 24. For example, the first component K1 may be dosed unto the first blade section 31 and the second component K2 may be dosed unto the second blade section 32. Due to the feeding effect of the dosing pumps 2, 3, the components K1, K2 are helically feed in the first helix direction W30, i.e. counter-clockwise, in the direction of the second blade element 37 of the first mixing stage 24.

During the transfer of the components K1, K2 from the first blade element 30 to the second blade element 37 of the first mixing stage 24, which is arranged immediately below said first blade element, the two components K1, K2 are turned over and thus intermixed due to the different helix directions W30, W37 of the blade elements 30, 37. Along the second blade element 37, the now already partially intermixed components K1, K2 are feed in the second helix direction W37 along the feed direction F to the subsequent first blade element 30 of the second mixing stage 25 and transferred to said first blade element and, in doing so, turned over again and intermixed further. This process is repeated at each mixing stage 24 to 29 until the homogeneously mixed product P exits at the nozzle section 13 for dosing.

The second blade element height H37 of the second blade element 37 being greater than the first blade element height H30 of the first blade element 30 facilitates feeding the components K1, K2 in the feed direction F, thereby making it possible to achieve a pressure reduction in comparison to known mixers, whose blade element have identical blade element heights. This effectively prevents excessive pressure build-up in the mixing device 10 and thus compressing the product P. The product P pressing out is significantly reduced in comparison with known mixers. It is possible to apply a product bead at a dosing start and a dosing end easier and without the formation of blobs.

In the case where the mixer 15 is used as a dynamic mixer, the drive mechanism 7 rotates the mixer 15 inside the mixing tube 11 about the central axis M15. A rotational direction DR (FIG. 4) of the mixer 15 preferably corresponds to the first helix direction W30. This means that the mixer 15 is driven left-handed or counter-clockwise. Due to the different helix directions W30, W37 of the blade elements 30, 37 of the mixing stages 24 to 29, the components K1, K2 are being fed against the feed direction F by means of the first blade element 30 and in feed direction F by means of the blade elements 37.

This means that the first blade elements 30 are operable to accumulate the components K1, K2 or to create the reverse turbulence, whereas, due to its opposite second helix direction W37, the second blade elements 37 feed the components K1, K2 in the feed direction F in the direction of the nozzle section 13. However, because the second blade element height H37 of the second blade element 37 is greater than the first blade element height H30 of the first blade element 30, the feeding effect of the mixer 15 is greater in the feed direction F than against the feed direction F. This means that the mixer 15 itself has a feeding effect.

Thus the components K1, K2 or the product P, respectively, can be fed with significantly reduced pressure build-up in the feed direction F, as compared to known mixers that, due to identical blade element heights, do not have a feeding effect themselves. This means that the second blade elements 37 are operable to feed the components K1, K2 in the feed direction F and/or to reduce pressure and the first blade elements 30 are operable to create the reverse turbulence or to accumulate the components K1, K2. A turning over or intermixing of the components K1, K2 always occurs at a transition from a first blade element 30 to a second blade element 37 and vice versa.

The compressible product P pressing out is thus exponentially minimized because the pressure build-up is reduced. Thus, the application at dosing start and dosing end is easier and cleaner. The mixing quality or the intermixing of the two components K1, K2 is thus better with reduced overall height, when viewed along the longitudinal direction L15. The speed of the drive mechanism 7 can also be reduced. This reduces shear forces acting on the components K1, K2 or the product P, respectively. Moreover, at the end of the dosing operation, the rotational direction DR is reversible so that the second blade elements 37 feed against the feed direction F. The product P is thereby pulled back from the nozzle section 13. This allows for a further reduction in the risk of the product P pressing out.

FIG. 8 shows a schematic partial view of another embodiment of a mixer 15. The mixer 15 according to FIG. 8 is different from the mixer according to FIGS. 2 to 7 in that the first blade element 30 and the second blade element 37 overlap one another. In particular, the first blade element 30 runs into the second blade element 37 and vice versa. Thus the blade sections 31, 32 are partially arranged between the blade sections 38, 39 and vice versa. The end edges 34, 40 or the end edges 33, 41 of the blade elements 30, 37, respectively, are thus positioned spaced apart by a projecting length U.

FIG. 9 shows a schematic partial view of another embodiment of a mixer 15. FIG. 10 shows a schematic top plan view of the mixer 15. The mixer 15 according to FIGS. 9 and 10 is different from the mixer according to FIGS. 2 to 7 in that the blade elements 30, 37 have a wall thickness tapering in the radial direction R15. This means that the wall thickness decreases, when viewed in the radial direction R15. Moreover, the blade elements 30, 37, in particular the blade sections 31, 32, 38, 39 of the blade elements 30, 37 are arcuately curved or bent, in particular curved or bent in a circular arc. A tangential transition is provided between the blade sections 31, 32, 38, 39 and the core element 16. The pitch of the second blade element 37 is, for example, three times the pitch of the first blade element 30.

FIG. 11 shows a schematic partial view of another embodiment of a mixer 15. FIG. 12 shows a schematic top plan view of the mixer 15. The mixer 15 according to FIGS. 11 and 12 is different from the mixer according to FIGS. 2 to 7 in that the blade elements 30, 37, in particular the blade sections 31, 32, 38, 39 of the blade elements 30, 37 are arcuately curved or bent, in particular shaped in a circular arc, when viewed in the radial direction R15. In contrast to the embodiment of the mixer according to FIGS. 9 and 10, a tangential transition is not provided between the blade sections 31, 32, 38, 39 and the core element 16. The wall thickness of the blade elements 30, 37 is preferably constant.

FIG. 13 shows a schematic partial view of another embodiment of a mixer 15. FIG. 14 shows a schematic top plan view of the mixer 15. The mixer 15 according to FIGS. 13 and 14 is different from the mixer according to FIGS. 2 to 7 in that the blade elements 30, 37 each comprise more than two blade sections 31, 32, 38, 39. The first blade element 30 comprises three blade sections 31, 32, 44, and the second blade element 37 also comprises three blade sections 38, 39, 45. The blade sections 31, 32, 44 of the first blade element 30 and the blade sections 38, 39, 45 are positioned at a circumferential angle α of 120° to each other.

FIG. 15 shows a schematic view of another embodiment of a mixer 15. The mixer 15 according to FIG. 15 is different from the mixer according to FIGS. 2 to 7 in that a different ratio of the blade element height H30, H37 is selected. The first blade element height H30 is, for example, 6.25 mm and the second blade element height H37 is, for example, 18.75 mm. The blade element height ratio between the blade element heights H30, H37 thus is 2/8 to 6/8, for example.

This means that in this embodiment of the mixer 15, the first blade element height H30 is smaller than in the embodiment of the mixer 15 according to FIGS. 2 to 7, and the second blade element height H37 is correspondingly greater. Due to the increased second blade element height H37 and the decreased first blade element height H30 a further pressure reduction in the mixing device 10 can be achieved, in particular during dynamic operation of the mixer 15. Furthermore, a feeding effect in the feed direction F is improved.

FIG. 16 shows a schematic view of another embodiment of a mixer 15. The mixer 15 according to FIG. 16 is different from the mixer according to FIGS. 2 to 7 in that lesser blade element heights H30, H37 are selected for the first blade element 30 and the second blade element 37. The first blade element height H30 is, for example, 7.5 mm and the second blade element height H37 is, for example, 12.5 mm.

This results again in a ratio of the blade element heights H30, H37 of ⅝ to ⅜. Due to the reduced blade element heights H30, H37, the mixer 15 according to FIG. 16 comprises not six but eight mixing stages 24 to 29. The number of mixing stages 24 to 29 is arbitrary, as mentioned above. The increased number of mixing stages 24 to 29 allows for an even better intermixing of the components K1, K2 to be achieved.

FIG. 17 shows a schematic view of another embodiment of a mixer 15. In this embodiment of the mixer 15, only one blade element 37 is provided. The second blade element height H37 may be 37.5 mm, for example. Considered in regard to the mixing area 23, this corresponds to 32/8. The second blade element 37 is in particular a feeding screw.

In addition to the first blade elements 30 and the second blade element 37, several third blade elements 47 are also provided. The third blade elements 47 are constructed identical to the first blade elements 30, but do not comprise the first helix direction W30 but the second helix direction W37 of the second blade elements 37. The blade elements 30, 47 are alternately arranged. The first blade element height H30 and a third blade element height H47 of the third blade elements 47 may be equal. For example, the blade element heights H30, H47 are each 9.37 mm. Here, not a first blade element 30 but a third blade element 47 directly abuts the mixer tip 17.

A ratio of the blade element heights H30, H47 is 4/8 to 4/8. The second blade element 37 arranged at the end of the mixer 15 having an enlarged second blade element height H37 allows for the product P to be fed against the feed direction F by reversing the rotational direction DR of the mixer 15 at the end of the dosing operation to prevent the product P from pressing out. This means that the second blade element 37 then no longer feeds the product P in the feed direction F but against the feed direction F. This allows for a particularly effective prevention of a dripping of the product P after the dosing operation is stopped. In addition, the dosing pumps 2, 3 are adapted to run in reverse to equalize pressure.

FIG. 18 shows a block diagram of a preferred embodiment of a method for manufacturing a mixer 15 as described above. The method is in particular an additive or a generative manufacturing method. For example, a 3D printing process may be used. With a 3D printing process, the mixer 15 is constructed in layers in any number of steps S1 to SN, for example from a powder bed, in particular from a plastic powder bed.

The use of a generative manufacturing method allows for the geometry of the mixer 15 to be designed arbitrarily complex. In particular geometries that cannot be produced or only produced with increased effort with traditional methods such as plastic injection molding, for example, due to difficult or the lack of demoldability.

Although the present invention has been described using examples, it can be modified in many ways.

### LIST OF REFERENCE CHARACTERS

1 Dosing device
2 Dosing pump
3 Dosing pump
4 Flow block
5 Channel
6 Channel
7 Drive mechanism
8 Drive member
9 Drive shaft
10 Mixing device
11 Mixing tube
12 Base section
13 Nozzle section
14 Support tube
15 Mixer
16 Core element
17 Mixer base
18 Mixer tip
19 Side face
20 Side face
21 Tip
22 Interface
23 Mixing area
24 Mixing stage
25 Mixing stage
26 Mixing stage
27 Mixing stage
28 Mixing stage
29 Mixing stage
30 Blade element
31 Blade section
32 Blade section
33 Terminating edge
34 Terminating edge
35 Blade base
36 Blade tip
37 Blade element
38 Blade section
39 Blade section
40 End edge
41 End edge
42 Blade base
43 Blade tip
44 Blade section
45 Blade section
46 Marking member
47 Blade element
B Width
DR Direction of rotation
D16 Diameter
D22 Diameter
D30 Diameter
D37 Diameter
F Feed direction
H17 Height
H18 Height
H23 Height
H30 Height
H37 Height
H47 Height
K1 Component
K2 Component
L15 Longitudinal direction
M15 Central axis
P Product
Q16 Cross-section
R15 Radial direction
S1 Step
SN Step
U Projecting length
U30 Circumference
U37 Circumference
W30 Helix direction
W37 Helix direction
α Circumferential angle

1. A dynamic mixer for a dynamic mixing operation for mixing a liquid or paste-like product, in particular a multi-component product, comprising
a core element,
a first blade element integrally formed with the core element and helically extending around the core element in a first helix direction, and
a second blade element integrally formed with the core element and helically extending around the core element in a second helix direction that is different from the first helix direction,
wherein the first blade element and the second blade element are arranged immediately adjacent, when viewed in a longitudinal direction of the mixer,
wherein the first blade element has a first blade element height, when viewed in a longitudinal direction, and
wherein the second blade element has a second blade element height that is different from the first blade element height, when viewed in the longitudinal direction.

2. The dynamic mixer according to claim 1, wherein the blade element feeding the product away from a mixer base of the mixer in a feed direction in the dynamic mixing operation of the mixer has the greater blade element height compared to the blade element feeding the product against the feed direction.

3. The dynamic mixer according to claim 1, wherein in the dynamic mixing operation of the mixer, the first helix direction matches a rotational direction of the mixer, and wherein the second helix direction is oriented against the rotational direction.

4. The dynamic mixer according to claim 1, wherein the first blade element has a first pitch and the second blade element has a second pitch different from the first pitch, or wherein the first blade element and the second blade element have an identical pitch.

5. The dynamic mixer according to claim 1, wherein the first blade element extends at least a quarter turn around the core element and/or wherein the second blade element extends at least a complete turn around the core element.

6. The dynamic mixer according to claim 1, wherein a diameter of the core element is larger than a wall thickness of the first blade element and/or the second blade element.

7. The dynamic mixer according to claim 1, wherein, when viewed along a longitudinal direction, a plurality of mixing stages is provided, each comprising a first blade element and a second blade element, and wherein a ratio of the first blade element height to the second blade element height of a respective mixing stage is variable.

8. The dynamic mixer according to claim 1, wherein the first blade element and/or the second blade element taper radially outward from the core element.

9. The dynamic mixer according to claim 1, wherein the mixer is built in layers by means of a generative manufacturing method, in particular by means of a 3D printing process, or wherein the mixer is produced by means of an injection molding process.

10. The dynamic mixer according to claim 1, wherein, when viewed in the longitudinal direction, the first blade element and the second blade element are arranged free of any spacing or are arranged spaced apart with a spacing of not more than 5 mm, preferably of not more than 4 mm, more preferably of not more than 3 mm, more preferably of not more than 2 mm, more preferably of not more than 1 mm, more preferably of not more than 0.5 mm, more preferably of not more than 0.25 mm, more preferably of not more than 0.1 mm.

11. The dynamic mixer according to claim 1, wherein, when viewed in the longitudinal direction, an end edge of the first blade element is arranged at the same height as an end edge of the second blade element, or wherein the first blade element runs into the second blade element, so that the end edge of the first blade element and the end edge of the second blade element are arranged spaced apart by a projecting length, when viewed in the longitudinal direction.

12. The dynamic mixer according to claim 1, wherein the first blade element comprises two blade sections, three blade sections or more than three blade sections and/or wherein the second blade element comprises two blade sections, three blade sections or more than three blade sections.

13. The dynamic mixer according to claim 1, wherein the first blade element and/or the second blade element are arcuately bent, in particular bent in a circular arc shape, when viewed in a radial direction of the mixer.

14. A dosing device for dosing a liquid or paste-like product, in particular a multi-component product, comprising
a first dosing pump for dosing a first component of the product,
a second dosing pump for dosing a second component of the product, and
a dynamic mixer according to claim 1 for mixing the first component with the second component.

15. The dosing device according to claim 14, further comprising a drive mechanism adapted for rotating the mixer about its central axis to dynamically mix the first component and the second component.
